(19) United States
(12) Patent Application Publication
(10) Pub. No.: US 2021/0108052 A1
(43) Pub. Date: Apr. 15, 2021

(54) METHODS FOR MAKING POLYMER COMPOSITIONS

(71) Applicant: Milliken & Company, Spartanburg, SC (US)

(72) Inventors: Xiaoyou Xu, Spartanburg, SC (US); Scott Trenor, Greenville, SC (US); Keith Keller, Spartanburg, SC (US); Joseph Peterson, Warren, PA (US); Nicolas Treat, Alpharetta, GA (US); Xinfei Yu, Greer, SC (US); Suchitra Datta, Spartanburg, SC (US)

(21) Appl. No.: 17/071,211

(22) Filed: Oct. 15, 2020

Related U.S. Application Data
(60) Provisional application No. 62/915,368, filed on Oct. 15, 2019.

(51) Int. Cl. C08L 23/04; C08L 23/10

(52) U.S. Cl. CPC C08L 23/04; C08L 23/10

(57) ABSTRACT

A method for making a polymer composition comprises the steps of providing a thermoplastic polymer, providing a compatibilizing agent, providing a peroxide compound, and melt mixing the thermoplastic polymer, compatibilizing agent, and peroxide compound. The compatibilizing agent comprises an ester compound formally derived from a polyol comprising three or more hydroxy groups and an aliphatic carboxylic acid comprising one or more carbon-carbon double bonds. A masterbatch composition comprises a thermoplastic binder, a peroxide compound, and an ester compound. A concentrate composition comprises an antioxidant and an ester compound.

### CROSS-REFERENCE TO RELATED PATENT APPLICATIONS

This application claims, pursuant to 35 U.S.C. § 119(e), priority to and the benefit of the filing date of co-pending U.S. Patent Application No. 62/915,368 filed on Oct. 15, 2019, the contents of which are hereby incorporated by reference.

### TECHNICAL FIELD OF THE INVENTION

This application is directed to methods for making polymer compositions, particularly polymer compositions exhibiting a desirable combination of a relatively high melt flow rate and relatively high impact resistance. The application also describes masterbatch and concentrate compositions that can be used to make such polymer compositions.

### BACKGROUND

The melt flow rate (MFR) of a polymer resin generally is a function of its molecular weight. In general, increasing the melt flow rate allows the resin to be processed at lower temperatures and to fill complex part geometries. Various prior art methods of increasing the melt flow rate involve melt-blending the resin in an extruder with a compound capable of generating free radicals, such as a peroxide. The weight average molecular weight of the polymer is reduced and the MFR is increased. Increasing the melt flow rate by decreasing the molecular weight of the polyolefin polymer, however, has been found in many cases to have a detrimental effect on the strength and impact resistance of the modified polymer. For example, decreasing the molecular weight of the polymer can significantly lower the impact resistance of the polymer. This lowered impact resistance can make the polymer unsuitable for use in certain applications or end uses. Accordingly, when extant technologies are utilized, one must strike a compromise between increasing the melt flow rate and undesirably decreasing the impact resistance of the polymer. This compromise often means that the melt flow rate is not increased to the desired level, which requires higher processing temperatures and/or results in lower throughputs.

A need therefore remains for additives and processes that can produce polymer compositions having an increased melt flow while preserving, or even improving, the impact resistance of the polymer. The methods and compositions described in this application seek to address this continued need.

### BRIEF SUMMARY OF THE INVENTION

In a first embodiment, the invention provides a method for making a polymer composition, the method comprising the steps of:

(a) providing a thermoplastic polymer;

(b) providing a compatibilizing agent, the compatibilizing agent comprising an ester compound formally derived from a polyol comprising three or more hydroxy groups and an aliphatic carboxylic acid comprising one or more carbon-carbon double bonds;

(c) providing a peroxide compound;

(d) feeding the thermoplastic polymer, the compatibilizing agent, and the peroxide compound to a melt mixing apparatus, wherein the peroxide compound is fed to the melt mixing apparatus in an amount to provide an initial concentration of about 10 to about 315 ppm of active oxygen based on the combined weight of the thermoplastic polymer, the compatibilizing agent, and the peroxide compound, and wherein the compatibilizing agent is fed to the melt mixing apparatus in an amount to provide an initial concentration of about 200 to about 10,000 ppm of the ester compound based on the combined weight of the thermoplastic polymer, the compatibilizing agent, and the peroxide compound; and

(e) processing the thermoplastic polymer, the compatibilizing agent, and the peroxide compound in the melt mixing apparatus at a temperature that exceeds the melting point of the thermoplastic polymer to form a polymer composition.

In a second embodiment, the invention provides a method for making a polymer composition, the method comprising the steps of:

(a) providing a thermoplastic polymer;

(b) providing a compatibilizing agent, the compatibilizing agent comprising an ester compound formally derived from a polyol comprising three or more hydroxy groups and an aliphatic carboxylic acid comprising one or more carbon-carbon double bonds;

(c) providing a peroxide compound;

(d) combining the thermoplastic polymer, the compatibilizing agent, and the peroxide compound to produce an intermediate composition, wherein the peroxide compound is combined with the thermoplastic polymer and the compatibilizing agent in an amount to provide about 10 to about 315 ppm of active oxygen in the intermediate composition, and wherein the compatibilizing agent is combined with the thermoplastic polymer and the peroxide compound in an amount to provide about 200 to about 10,000 ppm of the ester compound in the intermediate composition;

(e) heating the intermediate composition to a temperature that exceeds the melting point of the thermoplastic polymer;

(f) mixing the intermediate composition to produce a polymer composition; and

(g) cooling the polymer composition to a temperature at which it solidifies.

In a third embodiment, the invention provides a masterbatch composition comprising:

(a) a thermoplastic binder having a melting point of about 140° C. or less;

(b) a peroxide compound; and

(c) an ester compound formally derived from a polyol comprising three or more hydroxy groups and an aliphatic carboxylic acid comprising one or more carbon-carbon double bonds;

wherein the peroxide compound is present in the composition in an amount of about 1 wt. % or more based on the total weight of the masterbatch composition; and the ester compound is present in the composition in an amount of about 1 wt. % or more based on the total weight of the masterbatch composition.

In a fourth embodiment, the invention provides a concentrate composition comprising:

(a) an antioxidant selected from the group consisting of hindered phenol compounds, hindered amine compounds, phosphite compounds, phosphonite compounds, thio compounds, and mixtures thereof; and

(b) an ester compound formally derived from a polyol comprising three or more hydroxy groups and an aliphatic carboxylic acid comprising one or more carbon-carbon double bonds;

wherein the antioxidant is present in the concentrate composition in an amount of about 8 wt. % or more based on the total weight of the concentrate composition.

### DETAILED DESCRIPTION OF THE INVENTION

In a first embodiment, the invention provides a method for making a polymer composition, the method comprising the steps of (a) providing a thermoplastic polymer; (b) providing a compatibilizing agent; (c) providing a peroxide compound; (d) feeding the thermoplastic polymer, the compatibilizing agent, and the peroxide compound to a melt mixing apparatus; and (e) processing the thermoplastic polymer, the compatibilizing agent, and the peroxide compound in the melt mixing apparatus at a temperature that exceeds the melting point of the thermoplastic polymer to form a polymer composition.

The method of the invention can utilize any suitable thermoplastic polymer. In a preferred embodiment, the thermoplastic polymer is a polyolefin polymer. More specifically, the thermoplastic polymer preferably is a polyolefin polymer selected from the group consisting of polypropylenes (e.g., polypropylene homopolymers, polypropylene copolymers, and mixtures thereof), polyethylenes (e.g., high density polyethylene polymers, medium density polyethylene polymers, low-density polyethylene polymers, linear low-density polyethylene polymers, and mixtures thereof), and mixtures thereof.

In another preferred embodiment, the thermoplastic polymer is a heterophasic thermoplastic polymer comprising a continuous phase and a discontinuous phase, such as a polypropylene impact copolymer. Preferably, the continuous phase is a propylene polymer phase and the discontinuous phase is an ethylene polymer phase. In a preferred embodiment, the continuous phase is selected from the group consisting of polypropylene homopolymers and copolymers of propylene and up to 50 wt. % of one or more comonomers selected from the group consisting of ethylene and C₄-C₁₀ α-olefin monomers. Preferably, the propylene content of the continuous phase is about 80 wt. % or more. The continuous phase preferably is from about 5 wt. % to about 80 wt. % of the total weight of the thermoplastic polymer.

In another preferred embodiment, the discontinuous phase is selected from the group consisting of ethylene homopolymers and copolymers of ethylene and a comonomer selected from the group consisting of C₃-C₁₀ α-olefin monomers. Preferably, the ethylene content of the discontinuous phase is about 8 wt. % or more. More preferably, the ethylene content of the discontinuous phase is from about 8 wt. % to 90 wt. % (e.g., about 8 wt. % to about 80 wt. %). In another preferred embodiment, the ethylene content of the heterophasic thermoplastic polymer is from about 5 wt. % to about 30 wt. %.

In a particularly preferred embodiment, the continuous phase is selected from the group consisting of polypropylene homopolymers and copolymers of propylene and up to 50 wt. % of one or more comonomers selected from the group consisting of ethylene and C₄-C₁₀ α-olefin monomers as described above, and the discontinuous phase is selected from the group consisting of ethylene homopolymers and copolymers of ethylene and a comonomer selected from the group consisting of C₃-C₁₀ α-olefin monomers as described above.

Examples of heterophasic thermoplastic polymers that may be modified are impact copolymers characterized by a relatively rigid, polypropylene homopolymer matrix (continuous phase) and a finely dispersed phase of ethylene-propylene propylene rubber (EPR) particles. Polypropylene impact copolymers may be made in a two-stage process, where the polypropylene homopolymer is polymerized first and the ethylene-propylene rubber is polymerized in a second stage. Alternatively, the impact copolymer may be made in three or more stages, as is known in the art. Suitable processes may be found in the following references: U.S. Pat. No. 5,639,822 and 7,649,052 B2. Examples of suitable processes to make polypropylene impact copolymers are Spheripol®, Unipol®, Mitsui process, Novolen process, Spherizone®, Catalloy®, Chisso process, Innovene®, Borstare®, and Sinopec process. These processes could use heterogeneous or homogeneous Ziegler-Natta or metallocene catalysts to catalyze the polymerization reaction.

The heterophasic thermoplastic polymer may be formed by melt mixing two or more polymer compositions, which form at least two distinct phases in the solid state. By way of example, the heterophasic thermoplastic polymer may comprise three distinct phases. The heterophasic thermoplastic polymer may result from melt mixing two or more types of recycled polyolefin compositions. Accordingly, the step of providing “a heterophasic thermoplastic polymer” as described herein includes employing a polymer composition in the process that is already heterophasic, as well as melt mixing two or more polymer compositions during the process, wherein the two or more polymer compositions form a heterophasic thermoplastic polymer. For example, the heterophasic thermoplastic polymer may be made by melt mixing a polypropylene homopolymer and an ethylene /a-olefin copolymer, such as an ethylene/butene elastomer. Examples of suitable copolymers would be Engage™, Exact®, Vistamaxx®, Versify™, INFUSE™, Nordel™, Vistalon®, Exxelor™, and Affinity™. Furthermore, it will be understood that the miscibility of the polyolefin polymer components that form the heterophasic thermoplastic polymer may vary when the composition is heated above the melting point of the continuous phase in the system, yet the system will form two or more phases when it cools and solidifies. Examples of heterophasic thermoplastic polymers can be found in U.S. Pat. No. 8,207,272 B2 and EP 1 391 482 B1.

In one embodiment of the invention, the heterophasic thermoplastic polymer used in the method does not have any polyolefin constituents with unsaturated bonds. In particular, when the heterophasic thermoplastic polymer contains a propylene polymer phase and an ethylene polymer phase, both the propylene polymers in the propylene polymer phase and the ethylene polymers in the ethylene polymer phase are free of unsaturated bonds.

In another embodiment of those embodiments employing a heterophasic thermoplastic polymer, in addition to the propylene polymer and ethylene polymer components, the heterophasic thermoplastic polymer may include an elastomer, such as elastomeric ethylene copolymers, elastomeric propylene copolymers, styrene block copolymers, such as styrene-butadiene-styrene (SBS), styrene-ethylene-butylene-styrene (SEBS), styrene-ethylene-propylene-styrene (SEPS) and styrene-isoprene-styrene (SIS), plastomers, ethylene-propylene-diene terpolymers, LLDPE, LDPE, VLDPE, polybutadiene, polyisoprene, natural rubber, and amorphous polyolefins. The rubbers may be virgin or recycled.

Certain characteristics of the bulk heterophasic polymer composition (as measured prior to treatment with the compatibilizing agent) have been found to influence the physical property improvements (e.g., increase in impact strength) realized through the incorporation of the compatibilizing agent. In particular, with respect to the bulk characteristics of the heterophasic polymer composition, the ethylene preferably comprises about 6 wt. % or more, about 7 wt. % or more, about 8 wt. % or more, or about 9 wt. % or more of the total weight of the heterophasic polymer composition. The heterophasic polymer composition preferably contains about 10 wt. % or more, about 12 wt. % or more, about 15 wt. % or more, or about 16 wt. % or more xylene solubles or amorphous content. Further, about 5 mol. % or more, about 7 mol. % or more, about 8 mol. % or more, or about 9 mol. % or more of the ethylene present in the heterophasic polymer composition preferably is present in ethylene triads (i.e., a group of three ethylene monomer units bonded in sequence). Lastly, the number-average sequence length of ethylene runs (ethylene monomer units bonded in sequence) in the heterophasic polymer composition preferably is about 3 or more, about 3.25 or more, about 3.5 or more, about 3.75 or more, or about 4 or more. The mol. % of ethylene in ethylene triads and the number-average sequence length of ethylene runs can both be measured using ¹³C nuclear magnetic resonance (NMR) techniques known in the art. The heterophasic polymer composition can exhibit any one of the characteristics described in this paragraph. Preferably, the heterophasic polymer composition exhibits two or more of the characteristics described in this paragraph. Most preferably, the heterophasic polymer composition exhibits all of the characteristics described in this paragraph.

Certain characteristics of the ethylene phase of the heterophasic polymer composition (as measured prior to treatment with the compatibilizing agent) have also been found to influence the physical property improvements (e.g., increase in impact strength) realized through the incorporation of the compatibilizing agent. The characteristics of the ethylene phase of the composition can be measured using any suitable technique, such as temperature rising elution fractionation (TREF) and ¹³C NMR analysis of the fractions obtained. In a preferred embodiment, about 30 mol. % or more, about 40 mol. % or more, or about 50 mol. % or more of the ethylene present in a 60° C. TREF fraction of the heterophasic polymer composition is present in ethylene triads. In another preferred embodiment, about 30 mol. % or more, about 40 mol. % or more, or about 50 mol. % or more of the ethylene present in an 80° C. TREF fraction of the heterophasic polymer composition is present in ethylene triads. In another preferred embodiment, about 5 mol. % or more, about 10 mol. % or more, about 15 mol. % or more, or about 20 mol. % or more of the ethylene present in a 100° C. TREF fraction of the heterophasic polymer composition is present in ethylene triads. The number-average sequence length of ethylene runs present in a 60° C. TREF fraction of the heterophasic polymer composition preferably is about 3 or more, about 4 or more, about 5 or more, or about 6 or more. The number-average sequence length of ethylene runs present in an 80° C. TREF fraction of the heterophasic polymer composition preferably is about 7 or more, about 8 or more, about 9 or more, or about 10 or more. The number-average sequence length of ethylene runs present in a 100° C. TREF fraction of the heterophasic polymer composition preferably is about 10 or more, about 12 or more, about 15 or more, or about 16 or more. The heterophasic polymer composition can exhibit any one of the TREF fraction characteristics described above or any suitable combination of the TREF fraction characteristics described above. In a preferred embodiment, the heterophasic polymer composition exhibits all of the TREF fraction characteristics described above (i.e., the ethylene triad and number-average sequence length characteristics for the 60° C., 80° C., and 100° C. TREF fractions described above).

Heterophasic polymer compositions exhibiting the characteristics described in the two preceding paragraphs have been observed to respond more favorably to the addition of the compatibilizing agent than heterophasic polymer compositions that do not exhibit these characteristics. In particular, heterophasic polymer compositions exhibiting these characteristics show significant improvements in impact strength when processed according to the methods of the invention, whereas heterophasic polymer compositions that do not exhibit these characteristics show less marked improvements when processed under the same conditions. This differential response and performance has been observed even when the different polymer compositions have approximately the same total ethylene content (i.e., the percent ethylene in each polymer composition is approximately the same). This result is surprising and was not anticipated.

The compatibilizing agent utilized in the method preferably comprises an ester compound formally derived from a polyol comprising three or more hydroxy groups and an aliphatic carboxylic acid comprising one or more carbon-carbon double bonds. As used herein, the term “formally derived” is used in the same sense as in the definition of “esters” in IUPAC. Compendium of Chemical Terminology, 2nd ed. (the “Gold Book”), compiled by A. D. McNaught and A. Wilkinson. Blackwell Scientific Publications, Oxford (1997). Thus, the ester compound need not be made by direct reaction of the polyol with the aliphatic carboxylic acid. Rather, the ester compound can be made by reacting the polyol or a derivative thereof (e.g., an alkyl halide derivative of the polyol or a methanesulfonyl, p-toluensulfonyl, or trifluoromethylsulfonyl ester of the polyol) with the aliphatic carboxylic acid or a derivative thereof (e.g., an acid salt, an acid halide derivative of the aliphatic carboxylic acid, or an active ester derivative such as esters with nitrophenol, N-hydroxysuccinimide, or hydroxybenzotriazole). The ester compound preferably is formally derived by linking each of the hydroxy groups of the polyol with an aliphatic carboxylic acid. The polyol from which the ester compound is formally derived can be any suitable polyol comprising three or more hydroxy groups, such as glycerol, 2-(hydroxymethyl)-2-ethylpropane-1,3-diol, erythritol, threitol, arabitol, xylitol, ribitol, mannitol, sorbitol, galactitol, fucitol, iditol, inositol, volemitol, pentaerythritol, and mixtures thereof. In a preferred embodiment, the polyol is 2-(hydroxymethyl)-2-ethylpropane-1,3-diol.

The aliphatic carboxylic acid from which the ester compound is formally derived can be any suitable aliphatic carboxylic acid comprising one or more carbon-carbon double bonds, such as acrylic acid. Preferably, the aliphatic carboxylic acid is selected from the group consisting of C₄ or greater aliphatic carboxylic acids. More preferably, the aliphatic carboxylic acid is selected from the group consisting of C₄-C₁₈ aliphatic carboxylic acids (e.g., C₄-C₁₆ aliphatic carboxylic acids). Even more preferably, the aliphatic carboxylic acid is selected from the group consisting of C₄-C₁₀ aliphatic carboxylic acids. In a preferred embodiment, the aliphatic carboxylic acid comprises two or more carbon-carbon double bonds. In such an embodiment, at least two of the carbon-carbon double bonds in the aliphatic carboxylic acid preferably are conjugated. In a preferred embodiment, the aliphatic carboxylic acid is 2,4-hexadienoic acid. Thus, in a preferred embodiment, the ester compound is 2,2-bis[(1,3-pentadienylcarbonyloxy)methyl]butyl 2,4-hexadienoate, which can be formally derived from one equivalent of 2-(hydroxymethyl)-2-ethylpropane-1,3-diol with three equivalents of 2,4-hexadienoic acid.

Any suitable peroxide compound can be used in the method described above. Suitable peroxide compounds include, but are not limited to: 2,5-dimethyl-2,5-di(tert-butylperoxy)hexane, 2,5-dimethyl-2,5-di(tert-butyl peroxy)hexyne-3,3,6,6,9,9-pentamethyl-3-(ethyl acetate)-1,2,4,5-tetraoxy cyclononane, tert-butyl hydroperoxide, hydrogen peroxide, dicumyl peroxide, tert-butyl peroxy isopropyl carbonate, di-tert-butyl peroxide, p-chlorobenzoyl peroxide, dibenzoyl diperoxide, tert-butyl cumyl peroxide; tert-butyl hydroxyethyl peroxide, di-tert-amyl peroxide and 2,5-dimethylhexene-2,5-diperisononanoate, acetylcyclohexanesulphonyl peroxide, diisopropyl peroxydicarbonate, tert-amyl perneodecanoate, tent-butyl-perneodecanoate, tert-butylperpivalate, tert-amylperpivalate, bis(2,4-dichlorobenzoyl)peroxide, diisononanoyl peroxide, didecanoyl peroxide, dioctanoyl peroxide, dilauroyl peroxide, bis(2-methylbenzoyl)peroxide, disuccinoyl peroxide, diacetyl peroxide, dibenzoyl peroxide, tert-butyl per-2-ethylhexanoate, bis(4-chlorobenzoyl)peroxide, tert-butyl perisobutyrate, tert-butyl permaleate, 1,1 -bis(tert-butylperoxy)-3,5,5-trimethylcyclo-hexane, 1,1-bis(tert-butylperoxy)cyclohexane, tert-butyl peroxyisopropyl carbonate, tert-butyl perisononaoate, 2,5-dimethylhexane 2,5-dibenzoate, tert-butyl peracetate, tert-amyl perbenzoate, tert-butyl perbenzoate, 2,2-bis(tert-butylperoxy)butane, 2,2-bis(tert-butylperoxy)propane, dicumyl peroxide, 2,5-dimethylhexane 2,5-di-tert-butylperoxid, 3-tert-butylperoxy-3-phenyl phthalide, di-tert-amyl peroxide, α,α′-bis(tert-butylperoxyisopropyl)benzene, 3,5-bis(tert-butylperoxy)-3,5-dimethyl-1,2-dioxolane, di-tert-butyl peroxide, 2,5-dimethylhexyne 2,5-di-tert-butyl peroxide, 3,3,6,6,9,9-hexamethyl-1,2,4,5-tetraoxacyclononane, p-menthane hydroperoxide, pinane hydroperoxide, diisopropylbenzene mono-α-hydroperoxide, cumene hydroperoxide or tert-butyl hydroperoxide. In a preferred embodiment, the peroxide compound is 2,5-dimethyl-2,5-di(tert-butylperoxy)hexane.

In the method, the thermoplastic polymer, the compatibilizing agent, and the peroxide compound are fed to a melt mixing apparatus. The melt mixing apparatus can be any suitable apparatus that can heat the thermoplastic polymer to a temperature at which it is molten and mix the thermoplastic polymer, the compatibilizing agent, and the peroxide compound while the polymer is molten. The thermoplastic polymer, the compatibilizing agent, and the peroxide compound can be mixed prior to heating, or the thermoplastic polymer can be heated to the desired temperature followed by addition of the compatibilizing agent and peroxide compound. Alternatively, the thermoplastic polymer and the compatibilizing agent can be combined and then heated followed by addition of the peroxide compound (e.g., once the mixture is heated to a temperature above the melting point of the polymer). Suitable melt mixing apparatus include, but are not limited to, extruders, the reciprocating screw of injection molding machines, and high shear mixers. In a preferred embodiment of the first method, the melt mixing apparatus is an extruder. Thus, in an embodiment in which the melt mixing apparatus is an extruder, the method comprises the steps of feeding the thermoplastic polymer, the compatibilizing agent, and the peroxide compound to an extruder and passing the thermoplastic polymer, the compatibilizing agent, and the peroxide compound through the extruder at a temperature that exceeds the melting point of the thermoplastic polymer thereby forming a polymer composition. When an extruder is used, the thermoplastic polymer, the compatibilizing agent, and the peroxide compound can be simultaneously fed to the extruder's main inlet or hopper. Alternatively, the thermoplastic polymer can be fed to the extruder's main inlet or hopper, and the compatibilizing agent and peroxide compound can be introduced into the extruder through one or more side feeders. In another alternative, the thermoplastic polymer and the compatibilizing agent can be fed to the extruder's main inlet or hopper, and the peroxide compound can be introduced into the extruder through a side feed.

The compatibilizing agent and the peroxide compound can be fed to the melt mixing apparatus in any suitable amounts. Preferably, the compatibilizing agent is fed to the melt mixing apparatus in an amount to provide an initial concentration of about 200 to about 15,000 ppm of the ester compound based on the combined weight of the thermoplastic polymer, the compatibilizing agent, and the peroxide compound. More preferably, the compatibilizing agent is fed to the melt mixing apparatus in an amount to provide an initial concentration of about 200 to about 10,000 ppm (e.g., about 200 to about 8,000 ppm, about 200 to about 6,000 ppm, or about 200 to about 5,000 ppm) of the ester compound based on the combined weight of the thermoplastic polymer, the compatibilizing agent, and the peroxide compound.

Preferably, the peroxide compound is fed to the melt mixing apparatus in an amount to provide an initial concentration of about 10 to about 315 ppm of active oxygen based on the combined weight of the thermoplastic polymer, the compatibilizing agent, and the peroxide compound. More preferably, the peroxide compound is fed to the melt mixing apparatus in an amount to provide an initial concentration of about 50 to about 315 ppm of active oxygen based on the combined weight of the thermoplastic polymer, the compatibilizing agent, and the peroxide compound. Still more preferably, the peroxide compound is fed to the melt mixing apparatus in an amount to provide an initial concentration of about 50 to about 265 ppm of active oxygen based on the combined weight of the thermoplastic polymer, the compatibilizing agent, and the peroxide compound. Most preferably, the peroxide compound is fed to the melt mixing apparatus in an amount to provide an initial concentration of about 50 to about 215 ppm of active oxygen based on the combined weight of the thermoplastic polymer, the compatibilizing agent, and the peroxide compound. The amount of active oxygen provided by a given amount of a peroxide compound can be calculated using the following equation

$$Active oxygen ( ppm ) = \frac{16 \times n \times P \times C}{M}$$

In the equation, n is the number of peroxide groups in the peroxide compound, P is the purity of the peroxide compound, C is the concentration (in ppm) of the peroxide compound added to the system, and M is the molar mass of the peroxide compound. Thus, when 95% pure 2,5-dimethyl-2,5-di(tert-butylperoxy)hexane is added at an initial concentration of 500 ppm, the peroxide compound provides an initial concentration of 52.5 ppm of active oxygen.

As noted above, the thermoplastic polymer, the compatibilizing agent, and the peroxide compound are processed in the melt mixing apparatus at a temperature that exceeds the melting point of the thermoplastic polymer. In those embodiments in which the thermoplastic polymer is a heterophasic thermoplastic polymer, these components are heated to a temperature that exceeds the melting point of the continuous phase of the heterophasic thermoplastic polymer. By way of example, the components preferably are melt mixed at a temperature of about 160° C. to about 300° C. In those embodiments in which the thermoplastic polymer is a propylene impact copolymer, the components preferably are melt mixed at a temperature of about 180° C. to about 290° C.

In a second embodiment, the invention provides a method for making a polymer composition, the method comprising the steps of (a) providing a thermoplastic polymer; (b) providing a compatibilizing agent; (c) providing a peroxide compound; (d) combining the thermoplastic polymer, the compatibilizing agent, and the peroxide compound to produce an intermediate composition; (e) heating the intermediate composition to a temperature that exceeds the melting point of the thermoplastic polymer; (f) mixing the intermediate composition to produce a polymer composition; and (g) cooling the polymer composition to a temperature at which it solidifies.

The thermoplastic polymer, compatibilizing agent, and peroxide compound used in this second method embodiment can be any of the thermoplastic polymers, compatibilizing agents, and peroxide compounds discussed above in connection with the first method embodiment of the invention, including those preferred thermoplastic polymers, compatibilizing agents, and peroxide compounds identified in connection with the first method embodiment.

In this second method embodiment, any suitable amount of the compatibilizing agent can be used. Preferably, the compatibilizing agent is combined with the thermoplastic polymer and the peroxide compound in an amount to provide about 200 to about 15,000 ppm of the ester compound in the intermediate composition. More preferably, the compatibilizing agent is combined with the thermoplastic polymer and the peroxide compound in an amount to provide about 200 to about 10,000 ppm (e.g., about 200 to about 8,000 ppm, about 200 to about 6,000 ppm, or about 200 to about 5,000 ppm) of the ester compound in the intermediate composition.

Any suitable amount of the peroxide compound can be used in this second method embodiment. Preferably, the peroxide compound is combined with the thermoplastic polymer and the compatibilizing agent in an amount to provide about 10 to about 315 ppm of active oxygen in the intermediate composition. More preferably, the peroxide compound is combined with the thermoplastic polymer and the compatibilizing agent in an amount to provide about 50 to about 315 ppm of active oxygen in the intermediate composition. Still more preferably, the peroxide compound is combined with the thermoplastic polymer and the compatibilizing agent in an amount to provide about 50 to about 265 ppm of active oxygen in the intermediate composition. Most preferably, the peroxide compound is combined with the thermoplastic polymer and the compatibilizing agent in an amount to provide about 50 to about 215 ppm of active oxygen in the intermediate composition.

The second method embodiment differs from the first in that the thermoplastic polymer, compatibilizing agent, and peroxide compound are mixed prior to being heated. This method can be employed in those processes in which the components are dry blended prior to melt processing, such as certain compression molding processes. As with the first method embodiment, the components are heated to a temperature that exceeds the melting point of the thermoplastic polymer. In those embodiments in which the thermoplastic polymer is a heterophasic thermoplastic polymer, these components are heated to a temperature that exceeds the melting point of the continuous phase of the heterophasic thermoplastic polymer. By way of example, the components preferably are heated to a temperature of about 160° C. to about 300° C. In those embodiments in which the thermoplastic polymer is a propylene impact copolymer, the components preferably are heated to a temperature of about 180° C. to about 290° C.

While not wishing to be bound to any particular theory, the methods described above are believed to improve the physical properties of the thermoplastic polymer by linking polymer chains within the polymer matrix. In particular, when the thermoplastic polymer is a heterophasic thermoplastic polymer, the method is believed to create bonds between propylene polymers in the continuous phase and ethylene polymers in the discontinuous phase. These bonds are believed to be created when the peroxide compound breaks polymer chains in the polymer, which polymer chain scission produces an increase in the MFR of the polymer. Further, these broken polymer chains are believed to possess carbon-centered free radicals that can react with one of the carbon-carbon double bonds in the ester compound to produce a new carbon-carbon bond between the polymer chain and the ester compound. As this sequence of polymer chain scission and free radical addition to the ester compound progresses, it is believed that at least some of the ester compound in the polymer reacts to provide a bridge or link between the different polymers (e.g., the propylene polymer and the ethylene polymer) in the heterophasic polymer.

The methods described above can be used to produce polymer compositions that are rendered into a final form using any conventional polymer processing technique, such as injection molding, thin-wall injection molding, single-screw compounding, twin-screw compounding, Banbury mixing, co-kneader mixing, two-roll milling, sheet extrusion, fiber extrusion, film extrusion, pipe extrusion, profile extrusion, extrusion coating, extrusion blow molding, injection blow molding, injection stretch blow molding, compression molding, extrusion compression molding, compression blow forming, compression stretch blow forming, thermoforming, and rotomolding. Thermoplastic polymer articles made using the polymer composition formed by these methods can be comprised of multiple layers, with one or any suitable number of the multiple layers containing a polymer composition formed by these methods. By way of example, typical end-use products include containers, packaging, automotive parts, bottles, expanded or foamed articles, appliance parts, closures, cups, furniture, housewares, battery cases, crates, pallets, films, sheet, fibers, pipe, and rotationally molded parts.

In a third embodiment, the invention provides a masterbatch composition comprising (a) a thermoplastic binder, (b) a peroxide compound, and (c) an ester compound. Since the masterbatch composition contains both a peroxide compound and an ester compound as described herein, the masterbatch composition is believed to be well-suited for use in the practice of the methods described herein. In such uses, the masterbatch composition can be combined with a thermoplastic polymer (e.g., a heterophasic polypropylene impact copolymer) in an amount that provides the desired initial concentrations of both the peroxide compound and the ester compound.

The thermoplastic binder in the masterbatch composition can be any thermoplastic material that is capable of binding together the components of the masterbatch composition. The thermoplastic binder preferably has a melting point of about 140° C. or less, about 130° C. or less, about 120° C. or less, more preferably about 110° C. or less, about 100° C. or less, about 90° C. or less, about 80° C. or less, about 70° C. or less, about 60° C. or less, or about 50° C. or less. Suitable thermoplastic binders include, but are not limited to polypropylenes, polypropylene waxes, low-density polyethylenes, polyethylene waxes, propylene/ethylene copolymers (such as those sold under the name “Vistamaxx” by ExxonMobil Chemical), ethylene vinyl acetate copolymers, and mixtures thereof.

The peroxide compound and ester compound in the masterbatch composition can be any of the peroxide compounds and ester compounds discussed above in connection with the first method embodiment of the invention, including those preferred peroxide compounds and ester compounds identified in connection with the first method embodiment. Thus in a preferred embodiment, the ester compound is 2,2-bis[(1,3-pentadienylcarbonyloxy)methyl]butyl 2,4-hexadienoate. In another preferred embodiment, the peroxide compound is 2,5-dimethyl-2,5-di(tert-butylperoxy)hexane. Lastly, in a particularly preferred embodiment of the masterbatch composition, the ester compound is 2,2-bis[(1,3-pentadienylcarbonyloxy)methyl]butyl 2,4-hexadienoate, and the peroxide compound is 2,5-dimethyl-2,5-di(tert-butylperoxy)hexane.

The peroxide compound can be present in the masterbatch composition in any suitable amount. Preferably, the peroxide compound is present in the masterbatch composition in an amount of about 1 wt. % or more based on the total weight of the masterbatch composition. More preferably, the peroxide compound is present in the masterbatch composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the total weight of the masterbatch composition.

Preferably, the peroxide compound is present in the masterbatch composition in an amount of about 40 wt. % or less based on the total weight of the masterbatch composition. Thus, in a series of preferred embodiments, the peroxide compound is present in the masterbatch composition in an amount of about 1 wt. % to about 40 wt. %, about 2 wt. % to about 40 wt. %, about 3 wt. % to about 40 wt. %, about 4 wt. % to about 40 wt. %, about 5 wt. % to about 40 wt. %, about 6 wt. % to about 40 wt. %, about 7 wt. % to about 40 wt. %, about 8 wt. % to about 40 wt. %, about 9 wt. % to about 40 wt. %, or about 10 wt. % to about 40 wt. %, based on the total weight of the masterbatch composition.

The ester compound can be present in the masterbatch composition in any suitable amount. Preferably, the ester compound is present in the masterbatch composition in an amount of about 1 wt. % or more based on the total weight of the masterbatch composition. More preferably, the ester compound is present in the masterbatch composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the total weight of the masterbatch composition. Preferably, the ester compound is present in the masterbatch composition in an amount of about 40 wt. % or less based on the total weight of the masterbatch composition. Thus, in a series of preferred embodiments, the ester compound is present in the masterbatch composition in an amount of about 1 wt. % to about 40 wt. %, about 2 wt. % to about 40 wt. %, about 3 wt. % to about 40 wt. %, about 4 wt. % to about 40 wt. %, about 5 wt. % to about 40 wt. %, about 6 wt. % to about 40 wt. %, about 7 wt. % to about 40 wt. %, about 8 wt. % to about 40 wt. %, about 9 wt. % to about 40 wt. %, or about 10 wt. % to about 40 wt. %, based on the total weight of the masterbatch composition.

The masterbatch composition can contain other polymer additives in addition to the peroxide compound and the ester compound. Suitable additional polymer additives include, but are not limited to, antioxidants (e.g., phenolic antioxidants, phosphite antioxidants, and combinations thereof), anti-blocking agents (e.g., amorphous silica and diatomaceous earth), pigments (e.g., organic pigments and inorganic pigments) and other colorants (e.g., dyes and polymeric colorants), fillers and reinforcing agents (e.g., glass, glass fibers, talc, calcium carbonate, and magnesium oxysulfate whiskers), nucleating agents, clarifying agents, acid scavengers (e.g., metal salts of fatty acids, such as the metal salts of stearic acid, and dihydrotalcites), polymer processing additives (e.g., fluoropolymer polymer processing additives), polymer cross-linking agents, slip agents (e.g., fatty acid amide compounds derived from the reaction between a fatty acid and ammonia or an amine-containing compound), fatty acid ester compounds (e.g., fatty acid ester compounds derived from the reaction between a fatty acid and a hydroxyl-containing compound, such as glycerol, diglycerol, and combinations thereof), and combinations of the foregoing.

As noted above, the masterbatch composition can contain nucleating agents and/or clarifying agents in addition to the other components described above. Suitable nucleating agents include, but are not limited to, benzoate salts (e.g., sodium benzoate and aluminum 4-tert-butylbenzoate), 2,2′-methylene-bis-(4,6-di-tert-butylphenyl) phosphate salts (e.g., sodium 2,2′-methylene-bis-(4,6-di-tert-butylphenyl) phosphate or aluminum 2,2′-methylene-bis-(4,6-di-tert-butylphenyl)phosphate), bicyclo[2.2.1]heptane-2,3-dicarboxylate salts (e.g., disodium bicyclo[2.2.1]heptane-2,3-dicarboxylate or calcium bicyclo[2.2.1]heptane-2,3-dicarboxylate), cyclohexane-1,2-dicarboxylate salts (e.g., calcium cyclohexane-1,2-dicarboxylate, monobasic aluminum cyclohexane-1,2-dicarboxylate, dilithium cyclohexane-1,2-dicarboxylate, or strontium cyclohexane-1,2-dicarboxylate), and combinations thereof. For the bicyclo[2.2.1]heptane-2,3-dicarboxylate salts and the cyclohexane-1,2-dicarboxylate salts, the carboxylate moieties can be arranged in either the cis- or trans-configuration, with the cis- configuration being preferred. Suitable clarifying agents include, but are not limited to, trisamides and acetal compounds that are the condensation product of a polyhydric alcohol and an aromatic aldehyde. Suitable trisamide clarifying agents include, but are not limited to, amide derivatives of benzene-1,3,5-tricarboxylic acid, amide derivatives of 1,3,5-benzenetriamine, derivatives of N-(3,5-bis-formylamino-phenyl)-formamide (e.g., N-[3,5-bis-(2,2-dimethyl-propionylamino)-phenyl]-2,2-dimethyl-propionamide), derivatives of 2- carbamoyl-malonamide (e.g., N,N′-bis-(2-methyl-cyclohexyl)-2-(2-methyl-cyclohexylcarbamoyl)-malonamide), and combinations thereof. As noted above, the clarifying agent can be an acetal compound that is the condensation product of a polyhydric alcohol and an aromatic aldehyde. Suitable polyhydric alcohols include acyclic polyols such as xylitol and sorbitol, as well as acyclic deoxy polyols (e.g., 1,2,3-trideoxynonitol or 1,2,3-trideoxynon-1-enitol). Suitable aromatic aldehydes typically contain a single aldehyde group with the remaining positions on the aromatic ring being either unsubstituted or substituted. Accordingly, suitable aromatic aldehydes include benzaldehyde and substituted benzaldehydes (e.g., 3,4-dimethylbenzaldehyde, 3,4-dichlorobenzaldehyde, or 4-propylbenzaldehyde). The acetal compound produced by the aforementioned reaction can be a mono-acetal, di-acetal, or tri-acetal compound (i.e., a compound containing one, two, or three acetal groups, respectively), with the di-acetal compounds being preferred. Suitable acetal-based clarifying agents include, but are not limited to, the clarifying agents disclosed in U.S. Pat. Nos. 5,049,605; 7,157,510; and 7,262,236. Some particularly preferred clarifying agents include 1,3:2,4-bis-O-(phenylmethylene)-D-glucitol, 1,3:2,4-bis-O-[(4-methylphenyl)methylene]-D-glucitol, 1,3:2,4-bis-O-[(3,4-dimethylphenyl)methylene]-D-glucitol, 1,3:2,4-bis-O-[(3,4-dichlorophenyl)methylene]-D-glucitol, 1,2,3-trideoxy-4,6:5,7-bis-O-[(4-propylphenyl)methylene]nonitol, and mixtures thereof.

If present in the masterbatch composition, the nucleating agents and/or clarifying agents can be present in any suitable amount. Preferably, the nucleating agents and/or clarifying agents are present in an amount of about 1 wt. % or more based on the total weight of the masterbatch composition. More preferably, the nucleating agents and/or clarifying agents are present in the masterbatch composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the total weight of the masterbatch composition. Preferably, the nucleating agents and/or clarifying agents are present in the masterbatch composition in an amount of about 40 wt. % or less based on the total weight of the masterbatch composition. Thus, in a series of preferred embodiments, the nucleating agents and/or clarifying agents are present in the masterbatch composition in an amount of about 1 wt. % to about 40 wt. %, about 2 wt. % to about 40 wt. %, about 3 wt. % to about 40 wt. %, about 4 wt. % to about 40 wt. %, about 5 wt. % to about 40 wt. %, about 6 wt. % to about 40 wt. %, about 7 wt. % to about 40 wt. %, about 8 wt. % to about 40 wt. %, about 9 wt. % to about 40 wt. %, or about 10 wt. % to about 40 wt. %, based on the total weight of the masterbatch composition. When the masterbatch composition comprises two or more nucleating agents and/or clarifying agents, the combined amount of both preferably falls within one of the ranges recited above.

In a fourth embodiment, the invention provides a concentrate composition comprising (a) an antioxidant and (b) an ester compound. The concentrate composition preferably is solid (or semisolid) at ambient temperatures (e.g., temperatures of approximately 25° C.) to facilitate handling. The concentrate composition of this embodiment can be used in the methods described above as a means for introducing the ester compound.

The concentrate composition can contain any suitable antioxidant or mixture of antioxidants. Preferably, the concentrate composition comprises an antioxidant selected from the group consisting of hindered phenol compounds, hindered amine compounds, phosphite compounds, phosphonite compounds, thio compounds, and mixtures thereof. Suitable antioxidant compounds include, but are not limited to, pentaerythritol tetrakis(3-(3,5-di-tert-butyl-4-hydroxyphenyl)propionate) (CAS No. 6683-19-8), octadecyl 3-(3,5-di-tert-butyl-4-hydroxyphenyl)propionate (CAS No. 2082-79-3), tris(2,4-di-tert-butylphenyl) phosphite (CAS No. 31570-04-4), 3,9-bis[2,4-bis(1,1-dimethylethyl)phenoxy]- 2,4,8,10-tetraoxa-3,9-diphosphaspiro[5.5]undecane (CAS No. 26741-53-7), bis(1-octyloxy-2,2,6,6-tetramethyl-4-piperidyl)sebacate (CAS No. 129757-67-1), bis(1,2,2,6,6-pentamethyl-4-piperidyl)sebacate (CAS No. 41556-26-7), methy-1,2,2,6,6-pentamethyl-4-piperidyl sebacate (CAS No. 82919-37-7), didodecyl-3,3′-thiodipropionate (CAS No. 123-28-4), 3,3′-thiodipropionic acid dioctadecylester (CAS No. 693-36-7), and tetrakis (2,4-di-t-butylphenyl) 4,4′-biphenylene diphosphonate (CAS No. 119345-01-6). In a preferred embodiment, the concentrate composition comprises a hindered phenol antioxidant, more preferably a 2,6-di-tert-butylphenol compound (i.e., a compound comprising at least one 2,6-di-tert-butylphenol moiety).

The antioxidant can be present in the concentrate composition in any suitable amount. Preferably, the antioxidant is present in the concentrate composition in an amount of about 5 wt. % or more based on the total weight of the concentrate composition. More preferably, the antioxidant is present in the concentrate composition in an amount of about 8 wt. % or more or about 10 wt. % or more based on the total weight of the concentrate composition. Preferably, the antioxidant is present in the concentrate composition in an amount of about 85 wt. % or less (e.g., about 80 wt. % or less, about 70 wt. % or less, about 60 wt. % or less, or about 50 wt. % or less) based on the total weight of the concentrate composition. Thus, in a series of preferred embodiments, the antioxidant can be present in the concentrate composition in an amount of about 5 wt. % to about 85 wt. % (e.g., about 5 wt. % to about 80 wt. %, about 5 wt. % to about 70 wt. %, about 5 wt. % to about 60 wt. %, or about 5 wt. % to about 50 wt. %), about 8 wt. % to about 85 wt. % (e.g., about 8 wt. % to about 80 wt. %, about 8 wt. % to about 70 wt. %, about 8 wt. % to about 60 wt. %, or about 8 wt. % to about 50 wt. %), or about 10 wt. % to about 85 wt. % (e.g., about 10 wt. % to about 80 wt. %, about 10 wt. % to about 70 wt. %, about 10 wt. % to about 60 wt. %, or about 10 wt. % to about 50 wt. %). When the concentrate composition comprises two or more antioxidants, the combined amount of both antioxidants preferably falls within one of the ranges recited above.

As noted above, the concentrate composition comprises an ester compound. The ester compound in the concentrate composition can be any of the ester compounds discussed above in connection with the first method embodiment of the invention, including those preferred ester compounds identified in connection with the first method embodiment. The concentrate composition can contain any suitable amount of the ester compound. Preferably, the ester compound is present in the concentrate composition in an amount of about 1 wt. % or more based on the total weight of the concentrate composition. More preferably, the ester compound is present in the concentrate composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the total weight of the concentrate composition. Preferably, the ester compound is present in the concentrate composition in an amount of about 85 wt. % or less (e.g., about 80 wt. % or less, about 70 wt. % or less, about 60 wt. % or less, about 50 wt. % or less, or about 40 wt. % or less) based on the total weight of the concentrate composition. Thus, in a series of preferred embodiments, the ester compound is present in the concentrate composition in an amount of about 1 wt. % to about 85 wt. %, about 2 wt. % to about 85 wt. %, about 3 wt. % to about 85 wt. %, about 4 wt. % to about 85 wt. %, about 5 wt. % to about 85 wt. %, about 6 wt. % to about 85 wt. %, about 7 wt. % to about 85 wt. %, about 8 wt. % to about 85 wt. %, about 9 wt. % to about 85 wt. %, or about 10 wt. % to about 85 wt. %, based on the total weight of the concentrate composition.

As with the masterbatch composition, the concentrate composition can contain other polymer additives in addition to the antioxidant and ester compound. Suitable additional polymer additives include those discussed above in connection with the masterbatch composition of the invention, such as nucleating agents and clarifying agents. These polymer additives can be present in the concentrate composition in any suitable amounts. For example, if present in the concentrate composition, the nucleating agents and/or clarifying agents can be present in an amount of about 1 wt. % or more based on the total weight of the concentrate composition. More preferably, the nucleating agents and/or clarifying agents are present in the concentrate composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the total weight of the concentrate composition. Preferably, the nucleating agents and/or clarifying agents are present in the concentrate composition in an amount of about 80 wt. % or less based on the total weight of the concentrate composition. Thus, in a series of preferred embodiments, the nucleating agents and/or clarifying agents are present in the concentrate composition in an amount of about 1 wt. % to about 80 wt. %, about 2 wt. % to about 80 wt. %, about 3 wt. % to about 80 wt. %, about 4 wt. % to about 80 wt. %, about 5 wt. % to about 80 wt. %, about 6 wt. % to about 80 wt. %, about 7 wt. % to about 80 wt. %, about 8 wt. % to about 80 wt. %, about 9 wt. % to about 80 wt. %, or about 10 wt. % to about 80 wt. %, based on the total weight of the concentrate composition. When the concentrate composition comprises two or more nucleating agents and/or clarifying agents, the combined amount of both preferably falls within one of the ranges recited above.

The following examples further illustrate the subject matter described above but, of course, should not be construed as in any way limiting the scope thereof.

### EXAMPLE 1

This example demonstrates the differences in physical properties of polymer compositions made with different ester compounds.

Five polymer compositions (Samples 1-1 to 1-5) were produced using the formulations set forth in Table 1 below. Samples 1-3 to 1-5 each contained a sorbate ester compound. Sample 1-3 contained lauryl sorbate (LS), Sample 1-4 contained 1,6-hexanediol disorbate (HDS), and Samples 1-5 contained 2,2-bis[(1,3-pentadienylcarbonyloxy)methyl]butyl 2,4-hexadienoate (CAS No. 347377-00-8, hereinafter “BPCMBH”). The amount of sorbate ester compound used in each polymer composition was chosen to provide approximately the same equivalents of sorbate ester moieties in the initial composition prior to extrusion. To produce the polymer compositions, the sorbate ester compound (if used) was dissolved in acetone to give a clear solution, which was sprayed onto the indicated amount of Pro-fax SG702 impact copolymer pellets (from LyondellBasell). The acetone was then evaporated from the pellets. The indicated amount of 2,5-dimethyl-2,5-di(tert-butylperoxy)hexane (DBPH) was added to the pellets and mixed together in a bag.

TABLE 2
Formulations for Samples 1-1 to 1-5.

| | Resin Pellets | DBPH | LS | HDS | BPCMBH |
|---|---|---|---|---|---|
| Sample | (ppm) | (pm) | (ppm) | (ppm) | (ppm) |
| 1-1 | 1,000,000 | 0 | 0 | 0 | 0 |
| 1-2 | 999,000 | 1,000 | 0 | 0 | 0 |
| 1-3 | 997,072 | 1,000 | 1,928 | 0 | 0 |
| 1-4 | 997,946 | 1,000 | 0 | 1,054 | 0 |
| 1-5 | 998,044 | 1,000 | 0 | 0 | 956 |

To produce each polymer composition, the combined ingredients listed in Table 1 were extruded into pellets on a Prism twin screw extruder. The rotation speed was set at 400 rpm, and the temperature of the chamber was maintained at 230° C. Portions of the resulting pellets for each polymer composition were then used to measure melt flow rate at 230° C. (ASTM D1238). Pellets of each polymer composition were also molded to produce the specimens for physical property testing such as Notched Izod impact (ISO178) and the migration test described below.

Samples 1-3 to 1-5 were evaluated to determine the amount of ester compound that would migrate out of the polymer under specified conditions. High levels of migration are undesirable because of the potential for the sorbate ester compound to contaminate materials (e.g., food) that contacts the polymer, for example, in a food container. For each polymer composition, three rectangular pieces were cut from a 50 mil plaque using a die cutter. Each rectangular piece was placed in a separate 40 ml vial, and 20 ml of 95% ethanol was added to each vial using a volumetric dispenser. The vials were heated to and maintained at 66° C. for 2 hours and then allowed to cool to room temperature. The plaques were removed from the vials and the ethanol was analyzed to determine the amount of sorbate ester compound that had migrated into the ethanol. The measured concentration of sorbate ester compound in the ethanol was then used to determine the percentage of the sorbate ester compound that had migrated out of the plastic. The results of the migration, melt flow rate (MFR), and Notched Izod impact testing are set forth in Table 2 below.

TABLE 2
Testing results for Samples 1-1 to 1-5.

| | | | Migrated | % Migrated |
|---|---|---|---|---|
| | | | Ester | Ester |
| | MFR | Impact | Compound | Compound |
| Sample | (g/10 min) | (kJ/m²) | (ppm) | (wt. %) |
| 1-1 | 18.3 | 12.8 | N/A | N/A |
| 1-2 | 109.1 | 5.0 | N/A | N/A |
| 1-3 | 67.7 | 11.1 | 3.860 | 4.40% |
| 1-4 | 61.5 | 14.0 | 0.650 | 1.36% |
| 1-5 | 58.4 | 19.7 | 0.046 | 0.11% |

The addition of 1,000 ppm of DBPH dramatically increases the MFR from 18.3 to 109.1 g/10 min at the expense of a substantial decrease in Notched Izod impact from 12.8 to 5.0 kJ/m². As shown by the data for Samples 1-3 to 1-5, the addition of a sorbate ester compound reduced the MFR relative to the peroxide-only sample (Sample 1-2) while simultaneously increasing the Notched Izod impact. Indeed, Sample 1-5 showed an approximately 50% increase in impact relative to the virgin resin (Sample 1-1) even though the MFR of the polymer composition was over three times greater than the MFR of the virgin resin. This result is significant given the normally inverse relationship between MFR and impact, with impact typically decreasing as the MFR increases.

The data in Table 1 also shows that the ester compound derived from a polyol having at least three hydroxy groups (i.e., the BPCMBH used in Sample 1-5) exhibited dramatically lower migration than the ester compounds derived from polyols having one or two hydroxy groups (i.e., the LS and HDS used in Samples 1-3 and 1-4, respectively). Indeed, the sample made with BPCMBH showed over an order of magnitude less migration than the sample made with HDS. This significant reduction in migration is surprising given that the only substantive difference between the compositions is a modest difference in the structures of the two compounds (i.e., moving from two ester moieties to three ester moieties). This markedly reduced migration is believed to make the trifunctional ester compounds (i.e., ester compounds made from a polyol having three or more hydroxy groups) especially well-suited for use in applications where migration is a concern (e.g., food contact applications).

### EXAMPLE 2

This example demonstrates the physical properties of several polymer compositions produced in accordance with the invention.

Several polymer compositions were produced from a commercially available polypropylene impact copolymer (Pro-fax SG702 impact copolymer (from LyondellBasell)) using the formulations set forth in Table 3 below. Some polymer compositions were made using a compatibilizing agent according to the invention, which contained 2,2-bis[(1,3-pentadienylcarbonyloxy)methyl]butyl 2,4-hexadienoate (BPCMBH). When used, the compatibilizing agent was dissolved in acetone to give a clear solution. The resulting solution was then sprayed onto the indicated amount of polymer pellets, and the acetone was evaporated from the pellets. The indicated amount of 2,5-dimethyl-2,5-di(tert-butylperoxy)hexane (DBPH) was added to the pellets and mixed together in a bag. The DBPH used in making these polymer compositions had a purity of 95%.

To produce each polymer composition, the combined ingredients listed in Table 3 were extruded into pellets on a Prism twin screw extruder using conditions similar to those described in Example 1. Portions of the resulting pellets for each polymer composition were then used to measure melt flow rate at 230° C. (ASTM D1238), and pellets of each polymer composition were also molded to produce the specimens for Notched Izod impact testing (ISO178). The results of these measurements are included in Table 3.

To facilitate a determination of the physical property changes attributable to the addition of a compatibilizing agent according to the invention, the relationship between the MFR and Izod impact of the Pro-fax SG702 impact copolymer was investigated. In particular, the MFR and Izod impact value of the polymer compositions that did not contain any compatibilizing agent (i.e., Samples 2-1, 2-2, 2-3, 2-19, 2-34, 2-45, and 2-56) were plotted and a trendline was fitted to the plot to produce a mathematical equation expressing the observed relationship between the MFR and the Izod impact of the polymer. The fit of a trendline yielded the following mathematical equation:

I=1.897+12.795×e^{(-0.0121×MFR)}

In the equation, I is the Izod impact value (in kJ/m²) and MFR is the melt flow rate (in g/10 min). The R² value for the trendline was 0.996, indicating that the trendline fit the data very well. The quality of the fit also shows that the equation can be used to calculate an expected Izod impact value once the MFR of a composition containing this polymer has been measured. In this sense, the “expected Izod impact value” is the value that the vis-broken polymer is expected to exhibit at a given MFR in the absence of any compatibilizing agent. When a compatibilizing agent is used, this expected Izod impact value can then be compared to the measured Izod impact value to ascertain and quantify the effect of the compatibilizing agent on the impact resistance of the polymer (i.e., the “Change in Izod Impact” reported in Table 3 below).

TABLE 3
Formulation, MFR, Izod impact, and Change in
Izod impact for various polymer compositions.

| | | | | | | Expected | Change |
|---|---|---|---|---|---|---|---|
| | | Active | | | Notched | Izod | in Izod |
| | [DBPH] | [O] | BPCMBH | MFR | Izod | impact | Impact |
| Sample | (ppm) | (ppm) | (ppm) | (g/10 min) | (kJ/m²) | (kJ/m²) | (%) |
| 2-1 | 0 | 0 | 0 | 18.6 | 12.1 | N/A | N/A |
| 2-2 | 100 | 10.5 | 0 | 24.6 | 11.3 | N/A | N/A |
| 2-3 | 500 | 52.5 | 0 | 64.8 | 8.0 | N/A | N/A |
| 2-4 | 500 | 52.5 | 50 | 62.9 | 9.4 | 7.9 | 19.0 |
| 2-5 | 500 | 52.5 | 100 | 57.9 | 8.8 | 8.2 | 6.6 |
| 2-6 | 500 | 52.5 | 200 | 57.7 | 8.9 | 8.3 | 7.7 |
| 2-7 | 500 | 52.5 | 300 | 54.4 | 11.0 | 8.5 | 29.7 |
| 2-8 | 500 | 52.5 | 400 | 53.9 | 10.6 | 8.6 | 23.8 |
| 2-9 | 500 | 52.5 | 500 | 45.5 | 14.5 | 9.3 | 56.4 |
| 2-10 | 500 | 52.5 | 1000 | 40.1 | 16.3 | 9.8 | 66.3 |
| 2-11 | 500 | 52.5 | 2000 | 35.9 | 21.1 | 10.2 | 107.5 |
| 2-12 | 500 | 52.5 | 3000 | 34.0 | 26.7 | 10.4 | 156.8 |
| 2-13 | 500 | 52.5 | 4000 | 30.1 | 36.9 | 10.8 | 242.1 |
| 2-14 | 500 | 52.5 | 5000 | 29.6 | 38.7 | 10.8 | 256.8 |
| 2-15 | 500 | 52.5 | 6000 | 28.8 | 38.6 | 10.9 | 253.3 |
| 2-16 | 500 | 52.5 | 8000 | 24.4 | 41.5 | 11.4 | 263.6 |
| 2-17 | 500 | 52.5 | 10000 | 22.7 | 42.0 | 11.6 | 261.7 |
| 2-18 | 500 | 52.5 | 15000 | 19.3 | 40.4 | 12.0 | 235.7 |
| 2-19 | 1000 | 105 | 0 | 122.9 | 4.6 | N/A | N/A |
| 2-20 | 1000 | 105 | 50 | 110.4 | 7.8 | 5.3 | 48.6 |
| 2-21 | 1000 | 105 | 100 | 110.2 | 6.7 | 5.3 | 26.8 |
| 2-22 | 1000 | 105 | 200 | 108.4 | 8.9 | 5.3 | 66.5 |
| 2-23 | 1000 | 105 | 300 | 100.2 | 9.1 | 5.7 | 60.0 |
| 2-24 | 1000 | 105 | 400 | 94.3 | 10.0 | 6.0 | 67.1 |
| 2-25 | 1000 | 105 | 1000 | 58.4 | 19.7 | 8.2 | 140.0 |
| 2-26 | 1000 | 105 | 2000 | 49.8 | 18.8 | 8.9 | 111.6 |
| 2-27 | 1000 | 105 | 3000 | 41.7 | 32.2 | 9.6 | 235.1 |
| 2-28 | 1000 | 105 | 4000 | 35.4 | 41.0 | 10.2 | 301.2 |
| 2-29 | 1000 | 105 | 5000 | 30.3 | 39.3 | 10.8 | 264.6 |
| 2-30 | 1000 | 105 | 6000 | 20.8 | 39.8 | 11.8 | 236.1 |
| 2-31 | 1000 | 105 | 8000 | 14.3 | 40.7 | 12.7 | 221.3 |
| 2-32 | 1000 | 105 | 10000 | 10.0 | 41.4 | 13.2 | 212.9 |
| 2-33 | 1000 | 105 | 15000 | 3.3 | 41.3 | 14.2 | 191.3 |
| 2-34 | 2000 | 210 | 0 | 234.3 | 2.4 | N/A | N/A |
| 2-35 | 2000 | 210 | 500 | 133.4 | 8.7 | 4.4 | 95.5 |
| 2-36 | 2000 | 210 | 1000 | 138.5 | 8.8 | 4.3 | 105.9 |
| 2-37 | 2000 | 210 | 2000 | 92.4 | 11.6 | 6.1 | 90.0 |
| 2-38 | 2000 | 210 | 3000 | 56.1 | 13.7 | 8.4 | 63.5 |
| 2-39 | 2000 | 210 | 4000 | 48.2 | 17.4 | 9.0 | 92.8 |
| 2-40 | 2000 | 210 | 5000 | 38.5 | 23.1 | 9.9 | 132.9 |
| 2-41 | 2000 | 210 | 6000 | 27.3 | 34.5 | 11.1 | 210.9 |
| 2-42 | 2000 | 210 | 8000 | 20.5 | 37.1 | 11.9 | 212.4 |
| 2-43 | 2000 | 210 | 10000 | 16.5 | 39.7 | 12.4 | 220.5 |
| 2-44 | 2000 | 210 | 15000 | 4.0 | 40.4 | 14.1 | 186.7 |
| 2-45 | 2500 | 262.5 | 0 | 285.1 | 2.4 | N/A | N/A |
| 2-46 | 2500 | 262.5 | 500 | 226.4 | 4.0 | 2.7 | 46.2 |
| 2-47 | 2500 | 262.5 | 1000 | 171.6 | 5.6 | 3.5 | 61.3 |
| 2-48 | 2500 | 262.5 | 2000 | 82.4 | 9.2 | 6.6 | 39.3 |
| 2-49 | 2500 | 262.5 | 3000 | 52.4 | 10.9 | 8.7 | 25.3 |
| 2-50 | 2500 | 262.5 | 4000 | 46.6 | 12.5 | 9.2 | 35.9 |
| 2-51 | 2500 | 262.5 | 5000 | 38.7 | 14.9 | 9.9 | 50.8 |
| 2-52 | 2500 | 262.5 | 6000 | 37.1 | 15.2 | 10.1 | 51.1 |
| 2-53 | 2500 | 262.5 | 8000 | 26.9 | 24.4 | 11.1 | 119.3 |
| 2-54 | 2500 | 262.5 | 10000 | 20.7 | 37.6 | 11.9 | 216.9 |
| 2-55 | 2500 | 262.5 | 15000 | 8.3 | 36.9 | 13.5 | 174.0 |
| 2-56 | 3000 | 315 | 0 | 360.3 | 2.2 | N/A | N/A |
| 2-57 | 3000 | 315 | 500 | 272.1 | 3.0 | 2.4 | 26.6 |
| 2-58 | 3000 | 315 | 1000 | 199.6 | 4.5 | 3.0 | 47.7 |
| 2-59 | 3000 | 315 | 2000 | 98.7 | 6.6 | 5.8 | 13.7 |
| 2-60 | 3000 | 315 | 3000 | 63.4 | 9.9 | 7.8 | 25.9 |
| 2-61 | 3000 | 315 | 4000 | 49.9 | 10.8 | 8.9 | 21.2 |
| 2-62 | 3000 | 315 | 5000 | 44.4 | 12.2 | 9.4 | 30.2 |
| 2-63 | 3000 | 315 | 6000 | 41.6 | 11.4 | 9.6 | 17.9 |
| 2-64 | 3000 | 315 | 8000 | 29.6 | 13.9 | 10.8 | 27.9 |
| 2-65 | 3000 | 315 | 10000 | 19.3 | 15.9 | 12.0 | 32.6 |
| 2-66 | 3000 | 315 | 15000 | 6.0 | 19.3 | 13.8 | 40.2 |

As can be seen from the data in Table 3, the addition of the peroxide results in an increase in the MFR and a decrease in the Notched Izod impact of the resin relative to the virgin resin (compare Samples 2-2, 2-3, 2-19, 2-34, 2-45, and 2-56 to Sample 2-1). The magnitude of these changes is directly proportional to the amount of peroxide added, with the maximum change observed for the formulation made with 3,000 ppm of DBPH (which provided an initial concentration of 315 ppm of active oxygen).

The addition of a compatibilizing agent according to the invention (which contained the ester compound BPCMBH) reversed the peroxide's negative effect on the Notched Izod impact. Indeed, all the compositions containing the compatibilizing agent exhibited a higher Notched Izod impact than would have been expected for a resin having the same MFR (i.e., the compositions all showed a positive “Change in Izod Impact”). This beneficial effect on the Notched Izod impact was generally observed for compositions made with at least 200 ppm BPCMBH, with the changes being especially pronounced for compositions made with at least 500 ppm BPCMBH. At higher loadings of peroxide (e.g., 262.5 ppm of active oxygen), the increase in Notched Izod impact appeared to decrease as BPCMBH concentrations exceeded 10,000 ppm. Within these bounds, the amount of BPCMBH needed to produce the maximum increase in Notched Izod impact was directly proportional to the amount of peroxide/the amount of active oxygen. Thus, as the amount of active oxygen increased, it was necessary to use a greater amount of BPCMBH to yield the highest Notched Izod impact value. Further, the compositions made with the compatibilizing agent according to the invention generally maintained an increase in the MFR relative to the virgin polymer. However, this result was not observed for most of the compositions which contained more than 10,000 ppm of BPCMBH, which typically showed undesirable decreases in the MFR compared to the virgin polymer.

As can be seen from a comparison of the “Changed in Izod impact” values for Samples 2-57 to 2-66 and Samples 2-46 to 2-55, the compositions made with 315 ppm of active oxygen showed smaller improvements in impact relative to the compositions made with 262.5 ppm of active oxygen regardless of the amount of BPCMBH added. While not wishing to be bound to any particular theory, this is believed to be due to excessive polymer chain scission caused by high peroxide loadings. Thus, it is believed that active oxygen concentrations exceeding 315 ppm would not be suitable for achieving the desired effects of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A method for making a polymer composition, the method comprising the steps of:
(a) providing a thermoplastic polymer;
(b) providing a compatibilizing agent, the compatibilizing agent comprising an ester compound formally derived from a polyol comprising three or more hydroxy groups and an aliphatic carboxylic acid comprising one or more carbon-carbon double bonds;
(c) providing a peroxide compound;
(d) feeding the thermoplastic polymer, the compatibilizing agent, and the peroxide compound to a melt mixing apparatus, wherein the peroxide compound is fed to the melt mixing apparatus in an amount to provide an initial concentration of about 10 to about 315 ppm of active oxygen based on the combined weight of the thermoplastic polymer, the compatibilizing agent, and the peroxide compound, and wherein the compatibilizing agent is fed to the melt mixing apparatus in an amount to provide an initial concentration of about 200 to about 10,000 ppm of the ester compound based on the combined weight of the thermoplastic polymer, the compatibilizing agent, and the peroxide compound; and
(e) processing the thermoplastic polymer, the compatibilizing agent, and the peroxide compound in the melt mixing apparatus at a temperature that exceeds the melting point of the thermoplastic polymer to form a polymer composition.

2. The method of claim 1, wherein the thermoplastic polymer is a heterophasic thermoplastic polymer comprising a continuous phase and a discontinuous phase.

3. The method of claim 2, wherein the continuous phase is a propylene polymer phase and the discontinuous phase is an ethylene polymer phase.

4. The method of claim 3, wherein the continuous phase is selected from the group consisting of polypropylene homopolymers and copolymers of propylene and up to 50 wt. % of one or more comonomers selected from the group consisting of ethylene and C₄-C₁₀ α-olefin monomers.

5. The method of claim 3, wherein the discontinuous phase is selected from the group consisting of ethylene homopolymers and copolymers of ethylene and a comonomer selected from the group consisting of C₃-C₁₀ α-olefin monomers.

6. The method of claim 3, wherein the propylene content of the continuous phase is about 80 wt. % or more.

7. The method of claim 3, wherein the ethylene content of the discontinuous phase is about 8 wt. % or more.

8. The method of claim 7, wherein the ethylene content of the discontinuous phase is from about 8 wt. % to about 80 wt. %.

9. The method of claim 3, wherein the continuous phase is from about 5 wt. % to about 80 wt. % of the total weight of the thermoplastic polymer.

10. The method of claim 1, wherein the ester compound is formally derived by linking each of the hydroxy groups of the polyol with an aliphatic carboxylic acid.

11. The method of claim 1, wherein the polyol is 2-(hydroxymethyl)-2-ethylpropane-1,3-diol.

12. The method of claim 1, wherein the aliphatic carboxylic acid comprises two or more carbon-carbon double bonds, and at least two of the carbon-carbon double bonds are conjugated.

13. The method of claim 1, wherein the aliphatic carboxylic acid is selected from the group consisting of C₆-C₁₀ aliphatic carboxylic acids.

14. The method of claim 13, wherein the aliphatic carboxylic acid is 2,4-hexadienoic acid.

15. The method of claim 1, wherein the ester compound is 2,2-bis[(1,3-pentadienylcarbonyloxy)methyl]butyl 2,4-hexadienoate.

16. The method of claim 1, wherein the peroxide compound is 2,5-dimethyl-2,5-di(tert-butylperoxy)hexane.

17. A method for making a polymer composition, the method comprising the steps of:
(a) providing a thermoplastic polymer;
(b) providing a compatibilizing agent, the compatibilizing agent comprising an ester compound formally derived from a polyol comprising three or more hydroxy groups and an aliphatic carboxylic acid comprising one or more carbon-carbon double bonds;
(c) providing a peroxide compound;
(d) combining the thermoplastic polymer, the compatibilizing agent, and the peroxide compound to produce an intermediate composition, wherein the peroxide compound is combined with the thermoplastic polymer and the compatibilizing agent in an amount to provide about 10 to about 315 ppm of active oxygen in the intermediate composition, and wherein the compatibilizing agent is combined with the thermoplastic polymer and the peroxide compound in an amount to provide about 200 to about 10,000 ppm of the ester compound in the intermediate composition;
(e) heating the intermediate composition to a temperature that exceeds the melting point of the thermoplastic polymer;
(f) mixing the intermediate composition to produce a polymer composition; and
(g) cooling the polymer composition to a temperature at which it solidifies.

18. The method of claim 17, wherein the thermoplastic polymer is a heterophasic thermoplastic polymer comprising a continuous phase and a discontinuous phase.

19. The method of claim 18, wherein the continuous phase is a propylene polymer phase and the discontinuous phase is an ethylene polymer phase.

20. The method of claim 19, wherein the continuous phase is selected from the group consisting of polypropylene homopolymers and copolymers of propylene and up to 50 wt. % of one or more comonomers selected from the group consisting of ethylene and C₄-C₁₀ α-olefin monomers.

21. The method of claim 19, wherein the discontinuous phase is selected from the group consisting of ethylene homopolymers and copolymers of ethylene and a comonomer selected from the group consisting of C₃-C₁₀ α-olefin monomers.

22. The method of claim 19, wherein the propylene content of the continuous phase is about 80 wt. % or more.

23. The method of claim 19, wherein the ethylene content of the discontinuous phase is about 8 wt. % or more.

24. The method of claim 23, wherein the ethylene content of the discontinuous phase is from about 8 wt. % to about 80 wt. %.

25. The method of claim 19, wherein the continuous phase is from about 5 wt. % to about 80 wt. % of the total weight of the thermoplastic polymer.

26. The method of claim 17, wherein the ester compound is formally derived by linking each of the hydroxy groups of the polyol with an aliphatic carboxylic acid.

27. The method of claim 17, wherein the polyol is 2-(hydroxymethyl)-2-ethylpropane-1,3-diol.

28. The method of claim 17, wherein the aliphatic carboxylic acid comprises two or more carbon-carbon double bonds, and at least two of the carbon-carbon double bonds are conjugated.

29. The method of claim 17, wherein the aliphatic carboxylic acid is selected from the group consisting of C₆-C₁₀ aliphatic carboxylic acids.

30. The method of claim 29, wherein the aliphatic carboxylic acid is 2,4-hexadienoic acid.

31. The method of claim 17, wherein the ester compound is 2,2-bis[(1,3-pentadienylcarbonyloxy)methyl]butyl 2,4-hexadienoate.

32. The method of claim 17, wherein the peroxide compound is 2,5-dimethyl-2,5-di(tert-butylperoxy)hexane.
